(19) United States
(12) Patent Application Publication
(10) Pub. No.: US 2014/0062319 A1
(43) Pub. Date: Mar. 6, 2014

(54) LIGHT-EMITTING DIODE DRIVING APPARATUS

(71) Applicant: Beyond Innovation Technology Co., Ltd., Taipei City (TW)

(72) Inventors: Nan-Chuan Huang, Taipei City (TW); Fu-Kuo Yang, Taipei City (TW)

(21) Appl. No.: 13/942,717

(22) Filed: Jul. 16, 2013

(30) Foreign Application Priority Data
Sep. 3, 2012 (TW) 101132034

(51) Int. Cl. H05B 33/08

(52) U.S. Cl. CPC H05B 33/0815
USPC 315/186

(57) ABSTRACT

A light emitting diode driving apparatus suitable for driving a light emitting diode string is provided. The light emitting diode driving apparatus includes a buck power conversion circuit and a control chip. The buck power conversion circuit is coupled to the light emitting diode string and has a power switch path. The control chip is coupled to the buck power conversion circuit, and is configured to control the operation of the buck power conversion circuit. The control chip has a ground pin, wherein the ground pin is indirectly connected to the power switch path and is in a floating state.

### CROSS-REFERENCE TO RELATED APPLICATION

This application claims the priority benefit of Taiwan application serial no. 101132034, filed on Sep. 3, 2012. The entirety of the above-mentioned patent application is hereby incorporated by reference herein and made a part of this specification.

### BACKGROUND

1. Technical Field

The invention relates to a driving apparatus. Particularly, the invention relates to a light-emitting diode (LED) driving apparatus.

2. Related Art

A conventional light-emitting diode (LED) driving apparatus generally consists of a control chip, a power switch and a plug-in circuit, etc. The control chip can provide a driving signal to switch the power switch, such that an LED string can emit light based on a current generated through switching of the power switch.

Generally, besides providing the driving signal, the control chip may further provide a function of circuit protection or compensating a whole circuit stability, etc. Moreover, the functions provided by the control chip can be implemented by configuring corresponding circuit units in the control chip according to a design requirement of a designer in collaboration with a corresponding plug-in circuit.

Further, each of the circuit units in the control chip takes a voltage level of a ground pin of the control chip as a reference voltage level of the circuit unit, so as to achieve a stable operation of the circuit unit.

In a general LED driving apparatus, the designer generally provides a ground potential or a fixed reference potential to the ground pin of the control chip to serve as the reference voltage level of each of the circuit units. However, due to the circuit configuration, sometimes the voltage level of the ground pin is probably not the lowest voltage level of each pin in the control chip.

Since a configuration of the pins of the integrated control chip is equivalent to a PN junction, the ground pin is generally equivalent to a P-well, and the other pins can be equivalent to N-wells. In case that the voltage level of the ground pin is not the lowest voltage level, a voltage level difference between the pins may cause a problem of reverse conduction of the control chip such that a circuit characteristic of the control chip is spoiled. Even more, the control chip may be damaged.

### SUMMARY

The invention is directed to a light-emitting diode (LED) driving apparatus, which prevents a problem of reverse conduction probably generated when a control chip drives an LED string.

The invention is directed to a light-emitting diode (LED) driving apparatus, which is adapted to drive an LED string. The LED driving apparatus includes a buck power conversion circuit and a control chip. The buck power conversion circuit is coupled to the LED string and has a power switch path. The control chip is coupled to the buck power conversion circuit, and is configured to control an operation of the buck power conversion circuit. The control chip has a ground pin, and the ground pin is indirectly connected to the power switch path and is in a floating state.

In an embodiment of the invention, the buck power conversion circuit further includes a frequency setting circuit, the control chip further has an output pin, and the control chip includes a pulse width modulation (PWM) signal generation unit and a frequency setting unit. The PWM signal generation unit is operated under a power supply voltage to generate a PWM driving signal, and outputs the PWM driving signal through the output pin to switch a power switch on the power switch path, such that the LED string is operated under a constant current to emit light. The frequency setting unit is coupled to the PWM signal generation unit and the frequency setting circuit, and is configured to set a frequency of the PWM driving signal in response to an electrical characteristic of the frequency setting circuit during an initialization period of the LED driving apparatus.

In an embodiment of the invention, the power switch has a first terminal, a second terminal and a control terminal, the first terminal of the power switch receives the power supply voltage, the second terminal of the power switch is coupled to a ground potential, and the control terminal of the power switch is coupled to the output pin to receive the PWM driving signal.

In an embodiment of the invention, the frequency setting circuit includes a first resistor, a first end of the first resistor is coupled to the output pin, and a second end of the first resistor is coupled to the power switch path, where the frequency setting unit sets the frequency of the PWM driving signal in response to a resistance value of the first resistor during the initialization period.

In an embodiment of the invention, the buck power conversion circuit further includes a current sensing circuit, the control chip further has a sensing pin, and the control chip further includes a current sensing unit. The current sensing unit is coupled to the PWM signal generation unit, and is coupled to the current sensing circuit through the sensing pin, and is configured to adjust a duty cycle of the PWM driving signal in response to a current flowing through the current sensing circuit.

In an embodiment of the invention, the frequency setting circuit includes a first resistor, the first resistor is connected in series between the sensing pin and the power switch path, where the frequency setting unit sets the frequency of the PWM driving signal in response to a resistance value of the first resistor during the initialization period.

In an embodiment of the invention, the current sensing circuit includes a second resistor, a first end of the second resistor is coupled to the sensing pin and the power switch path, and a second end of the second resistor is coupled to the ground pin, where a voltage level of the sensing pin is greater than a voltage level of the ground pin during a period when the LED driving apparatus drives the LED string.

In an embodiment of the invention, the control chip further has a power supply pin, and the LED driving apparatus further includes a direct current (DC) voltage generation circuit. The DC voltage generation circuit is configured to generate the power supply voltage. The control chip receives the power supply voltage through the power supply pin, and is operated under the power supply voltage to control the operation of the buck power conversion circuit.

In an embodiment of the invention, the DC voltage generation circuit includes an alternating current (AC) power supply and a bridge rectifier. The AC power supply is configured to provide an AC voltage. The bridge rectifier is coupled to the AC power supply, and is configured to rectify the AC voltage to generate the power supply voltage.

In an embodiment of the invention, the buck power conversion circuit further includes a voltage dividing-voltage regulating circuit, the control chip further has a detection pin, and the control chip further includes a voltage detection dimming unit. The voltage detection dimming unit is coupled to the DC voltage generation circuit through the detection pin and the voltage dividing-voltage regulating circuit, and is configured to adjust the duty cycle of the PWM driving signal in response to a turn-on/off state of the AC power supply.

In an embodiment of the invention, the DC voltage generation circuit further includes a diode and a voltage regulation capacitor. An anode of the diode is coupled to the bridge rectifier, and a cathode of the diode is coupled to the power supply pin of the control chip. The voltage regulation capacitor is coupled between the cathode of the diode and a ground voltage.

In an embodiment of the invention, the voltage detection dimming unit obtains a detection voltage in response to a voltage of the anode on the diode, and compares the detection voltage with a reference detection voltage to obtain the turn-on/off state of the AC power supply.

In an embodiment of the invention, the control chip further includes an over-voltage protection unit. The over-voltage protection unit is coupled to the PWM signal generation unit, and is configured to detect whether the power supply voltage exceeds a predetermined upper limit voltage, where when the power supply voltage exceeds the predetermined upper limit voltage, the PWM signal generation unit stops generating the PWM driving signal.

In an embodiment of the invention, the control chip further includes a low-voltage locking unit. The low-voltage locking unit is coupled to the PWM signal generation unit, and is configured to detect whether the power supply voltage exceeds a predetermined lower limit voltage, where when the power supply voltage does not exceed the predetermined lower limit voltage, the PWM signal generation unit stops generating the PWM driving signal.

In an embodiment of the invention, the control chip further includes an over-temperature protection unit. The over-temperature protection unit is coupled to the PWM signal generation unit, and is configured to detect whether a temperature of the control chip exceeds a temperature threshold, where when the temperature of the control chip exceeds the temperature threshold, the PWM signal generation unit stops generating the PWM driving signal.

In an embodiment of the invention, an electricity feedback circuit is coupled to the power supply pin and the anode of the LED string, and is configured to provide a feedback current to the power supply pin.

In an embodiment of the invention, the buck power conversion circuit further includes a compensation circuit, the control chip further has a compensation pin, and the control chip further includes a compensation unit. The compensation unit is coupled to the compensation circuit through the compensation pin, where the compensation unit provides a compensation signal to adjust the duty cycle of the PWM driving signal.

In an embodiment of the invention, the buck power conversion circuit further includes a filter circuit. The filter circuit is coupled between the ground pin and the LED string, and is configured to generate the constant current to drive the LED string in response to a switch operation of the power switch.

In an embodiment of the invention, the filter circuit includes an inductor and a capacitor. A first end of the inductor is coupled to the output pin, and a second end of the inductor is coupled to the anode of the LED string. A first end of the capacitor is coupled to the second end of the inductor and the anode of the LED string, and a second end of the capacitor is coupled to the ground potential.

According to the above descriptions, in the LED driving apparatus of the invention, by indirectly coupling the ground pin of the control chip to the power switch path through a circuit device, the ground pin of the control chip has the lowest voltage level in the control chip, so as to avoid the problem of reverse conduction between the pins of the control chip.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a light-emitting diode (LED) driving apparatus according to an embodiment of the invention.

FIG. 2 is a schematic diagram of an LED driving apparatus according to another embodiment of the invention.

FIG. 3 is a schematic diagram of a control chip according to an embodiment of the invention.

FIG. 4 is a partial schematic diagram of an LED driving apparatus according to still another embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

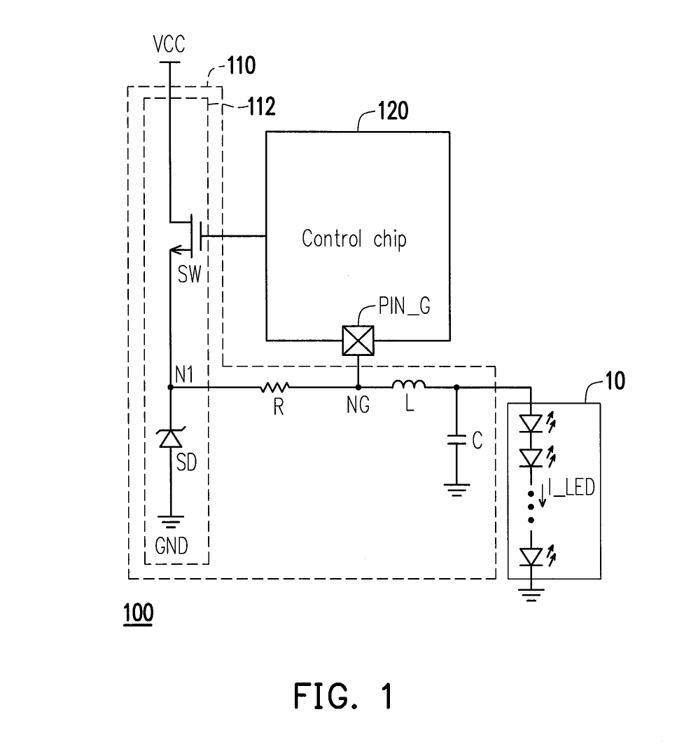

FIG. 1 is a schematic diagram of a light-emitting diode (LED) driving apparatus according to an embodiment of the invention. In the present embodiment, the LED driving apparatus 100 is at least adapted to drive an LED string 10. Referring to FIG. 1, the LED driving apparatus 100 includes a buck power conversion circuit 110 and a control chip 120. The buck power conversion circuit 110 is coupled to the LED string 10 and has a power switch path 112. The control chip 120 is coupled to the buck power conversion circuit 110, and is configured to control an operation of the buck power conversion circuit 110.

In the present embodiment, the buck power conversion circuit 110 is, for example, a circuit structure composed of a power switch SW, a Schottky diode SD, a resistor R, an inductor L and a capacitor C.

In the structure of the buck power conversion circuit 110 of FIG. 1, the power switch SW is switched to be turned on or turned off in response to a driving signal provided by the control chip 120, such that the buck power conversion circuit 110 can drive the LED string 10 in response to the switching of the power switch SW and a power supply voltage VCC. The Schottky diode SD is used to form a circuit-loop when the power switch SW is turned off, and the inductor L and the capacitor C can be used to provide a filter function to produce a constant current to drive the LED string 10.

Here, configuration of the Schottky diode SD, the inductor L, and the capacitor C is a design choice. In other words, in other embodiments, those skilled in the art can use the other voltage regulation component or voltage regulation circuit structure to implement the function of the Schottky diode SD, and can use other filter devices to implement the function of the inductor L and the capacitor C in the buck power conversion circuit 110, and the invention is not limited to the configuration shown in FIG. 1.

In detail, the power switch path 112 is a bias path composed of the power switch SW and the Schottky diode SD. When the power switch SW is turned on in response to the driving signal provided by the control chip 120, the buck power conversion circuit 110 provides a node N1 with a stable bias through the power switch path 112, and the inductor L stores energy in response to a voltage of the node N1, and accordingly produces a driving current I_LED. When the power switch SW is turned off in response to the driving signal provided by the control chip 120, the inductor L releases the electric energy to continually produce the driving current I_LED.

Although the inductor L makes the driving current I_LED to slightly oscillate (or swing) in response to the energy storage and release operations during a period of switching the power switch SW, in case that the driving signal is a pulse width modulation (PWM) signal and a frequency thereof is fast enough, a variation range of the driving current I_LED is very small, and the driving current I_LED can be regarded as a constant current.

On the other hand, a ground pin PIN_G of the control chip 120 is coupled to a node NG, and a voltage level of the node NG is taken as a reference voltage level of each circuit unit in the control chip 120.

In detail, the voltage level of the node NG is constructed according to the voltage level of the node N1 and a voltage drop caused by the resistor R. During the turn-on period of the power switch SW, the buck power conversion circuit 110 generates a current flowing through the power switch SW, the node N1, the resistor R and the inductor L, i.e. a current with a current direction from the node N1 to the node NG. Therefore, regardless of a magnitude of the voltage level of the node N1, or a magnitude of the current flowing through the resistor R, the voltage level of the node NG is always smaller than the voltage level of the node N1 in response to the voltage drop of the resistor R.

In this way, the voltage level of the node NG is smaller than the voltage level of any node in the buck power conversion circuit 110, such that a pin corresponding to the other circuit unit in the control chip 120 does not have a voltage level lower than that of the ground pin PIN_G regardless of any node of the buck power conversion circuit 110 being coupled to the pin.

Further, since the ground pin PIN_G of the control chip 120 is indirectly connected to the power switch path 112 and is in a floating state, the ground pin PIN_G has the lowest voltage level in the control chip 120. Therefore, the control chip 120 does not have the problem of reverse conduction between the pins. The indirect connection refers to that the ground pin PIN_G is coupled to the power switch path 112 through at least one circuit device capable of producing the voltage drop. Moreover, the situation that the ground pin PIN_G is in the floating state represents that the voltage level of the ground pin PIN_G is changed along with a magnitude of the current flowing through the resistor R, so as to maintain the lowest voltage level in the control chip 120.

It should be noticed that the resistor R configured between the node N1 and the node NG is only an example, and any circuit device and structure capable of producing the voltage drop and floating the ground pin PIN_G can be used to replace the resistor R, which is not limited by the invention.

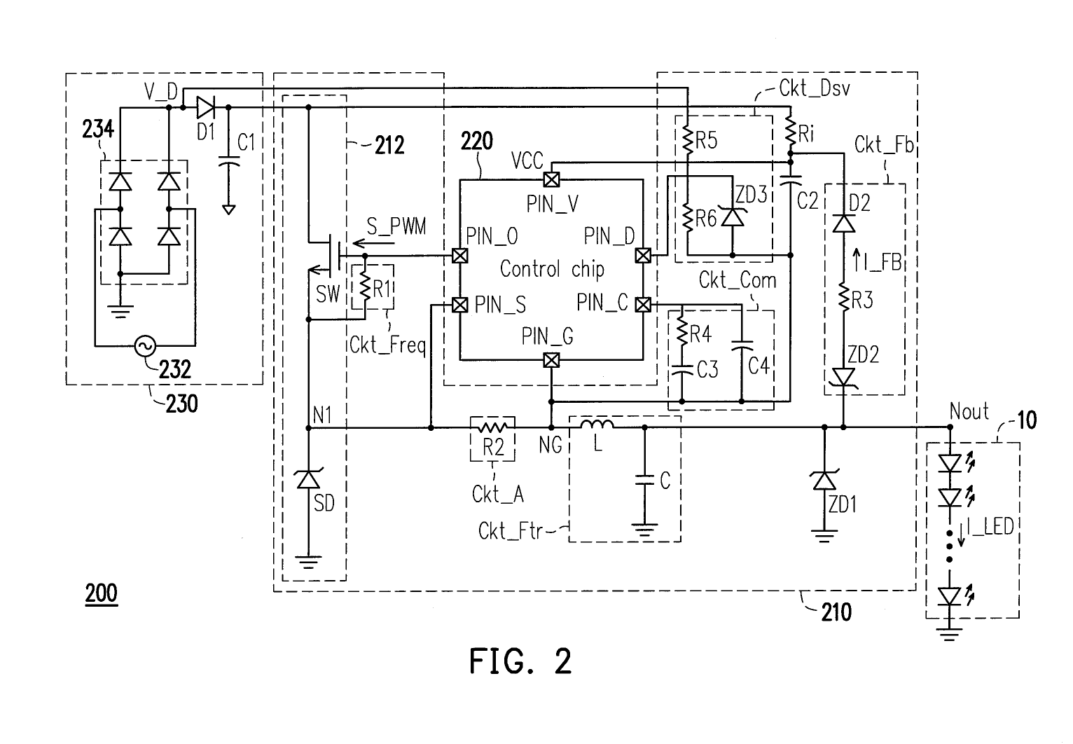

Referring to FIG. 2 to further describe the embodiment of the invention, and FIG. 2 is a schematic diagram of an LED driving apparatus according to another embodiment of the invention.

In the present embodiment, the LED driving apparatus 200 includes a buck power conversion circuit 210, a control chip 220 and a DC voltage generation circuit 230. The buck power conversion circuit 210 is coupled to the LED string 10, and has a power switch path 212. The control chip 220 is coupled to the buck power conversion circuit 210, and is configured to control the operation of the buck power conversion circuit 210. The DC voltage generation circuit 230 is configured to generate the power supply voltage VCC required by the buck power conversion circuit 210 and the control chip 220.

Regarding a structure of the buck power conversion circuit 210, the buck power conversion circuit 210 includes a power switch path 212, a frequency setting circuit Ckt_Freq, a current sensing circuit Ckt_A, a filter circuit Ckt_Ftr, a electricity feedback circuit Ckt_Fb, a compensation circuit Ckt_Com, a resistor Ri, a capacitor C2 and a Zener diode ZD1. The power switch path 212 is a bias path composed of the power switch SW and the Schottky diode SD. The filter circuit Ckt_Ftr is implemented by an inductor L and a capacitor C. The Zener diode ZD1 is used to ensure voltage stableness of a node Nout.

In detail, the power switch SW of the power switch path 112 has a first terminal, a second terminal and a control terminal, where the first terminal of the power switch SW is coupled to the DC voltage generation circuit 230 to receive the power supply voltage VCC, the second terminal of the power switch SW is coupled to a ground potential GND through the node N1 and the Schottky diode SD, and the control terminal of the power switch SW is coupled to an output pin PIN_O of the control chip 220 to receive a PWM driving signal S_PWM output by the control chip 220.

The filter circuit Ckt_Ftr is coupled between the node NG (equivalent to be coupled to the output pin PIN_G of the control chip 220) and the LED string 10, and generates the constant current to drive the LED string 10 in response to the switch operation of the power switch SW.

Further, a first end of the inductor L of the filter circuit Ckt_Ftr is coupled to the node NG, and a second end of the inductor L is coupled to the output node Nout (equivalent to an anode of the LED string 10), and a first end of the capacitor C of the filter circuit Ckt_Ftr is coupled to the second end of the inductor L and the output node Nout, and a second end of the capacitor C is coupled to the ground potential GND.

On the other hand, the buck power conversion circuit 210 is configured with the frequency setting circuit Ckt_Freq, the current sensing circuit Ckt_A, the electricity feedback circuit Ckt_Fb and the compensation circuit Ckt_Com corresponding to various circuit units of the control chip 220, such that the control chip 220 can normally control the operation of the buck power conversion circuit 210.

In the present embodiment, the control chip 220 can provide a circuit protection function, a segmental dimming function, a driving signal frequency adjustment function and a circuit stableness compensation function according to the included circuit units when driving the LED string 10. The circuit units of the control chip 220 of the LED driving apparatus 200 and the corresponding functions thereof are described below.

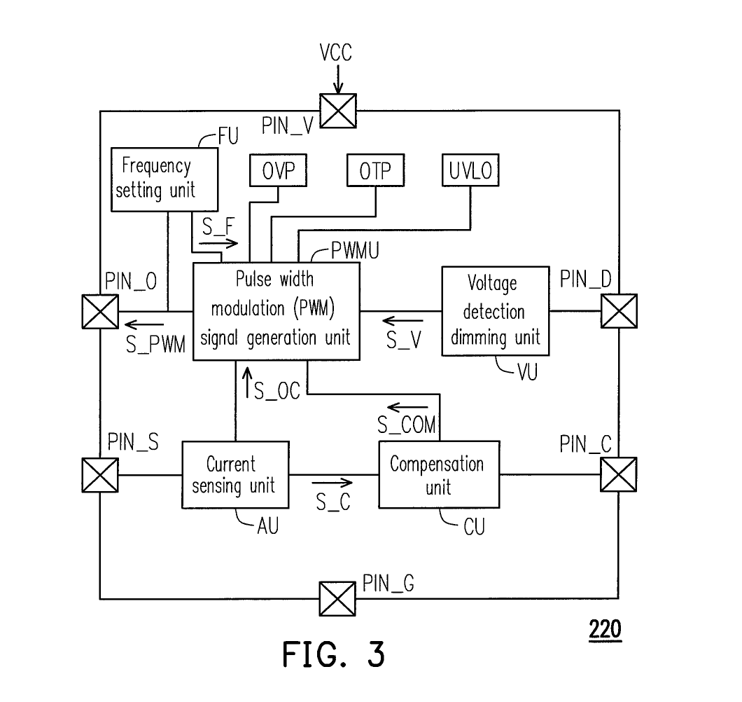

FIG. 3 is a schematic diagram of a control chip according to an embodiment of the invention. Referring to FIG. 3, in the present embodiment, the control chip 220 is, for example, a 6-pin chip structure including a power supply pin PIN_V, a detection pin PIN_D, an output pin PIN_O, a sensing pin PIN_S and a compensation pin PIN_C, though the invention is not limited thereto. The control chip 220 includes a voltage detection dimming unit VU, a PWM signal generation unit PWMU, a frequency setting unit FU, a current sensing unit AU, an over-voltage protection unit OVP, an over-temperature protection unit OTP, a low voltage locking unit UVLO and a compensation unit CU. The voltage detection dimming unit VU is coupled to the DC voltage generation circuit 230 through the detection pin PIN_D. The PWM signal generation unit PWMU, the current sensing unit AU and the compensation unit CU are respectively coupled to the buck power conversion circuit 210 through the output pin PIN_O, the sensing pin PIN_S and the compensation pin PIN_C. The control chip 220 receives the power supply voltage VCC through the power supply pin PIN_V, such that each of the circuit units can operate under the power supply voltage VCC to control the operation of the buck power conversion circuit 210. Moreover, ground terminals (not shown) of the circuit units are commonly coupled to the ground pin PIN_G, and the voltage level of the ground pin PIN_G is taken as a reference voltage level.

Referring to FIG. 2 and FIG. 3, the DC voltage generation circuit 230 of the present embodiment can be implemented through an AC power supply 232 and a bridge rectifier 234, though the invention is not limited thereto. Moreover, the DC voltage generation circuit 230 further includes a diode D1 and a voltage regulation capacitor C1. An anode of the diode D1 is coupled to the bridge rectifier 234, and a cathode of the diode D1 is coupled to the power supply pin PIN_V of the control chip 220 through a resistor Ri. The voltage regulation capacitor C1 is coupled between the cathode of the diode D1 and the ground voltage GND. The DC voltage generation circuit 230 can provide the stable power supply voltage VCC through charging/discharging of the voltage regulation capacitor C1.

Under the structure of the DC voltage generation circuit 230, the voltage detection dimming unit VU can adjust a duty cycle of the PWM driving signal S_PWM output by the control chip 220 in response to a turn-on/off state of the AC power supply 232.

In detail, the voltage detection dimming unit VU can be coupled to the anode of the diode D1 through the detection pin and a voltage dividing-voltage regulating circuit Ckt_Dsv of the buck power conversion circuit 210, such that the voltage detection dimming unit VU can obtain a detection voltage V_D in response to the voltage on the anode of the diode D1, and obtain the turn-on/off state of the AC power supply 232 by comparing the detection voltage with the reference detection voltage. Therefore, the control chip 220 can adjust the duty cycle of the output PWM driving signal according to the turn-on/off state of the AC power supply 232, so as to change a light-emitting intensity of the LED string 10 to implement the segmental dimming function. Here, the voltage dividing-voltage regulating circuit Ckt_Dsv can divide the voltage on the anode of the diode D1 by using the resistors R5 and R6, so as to obtain the corresponding detection voltage VD, and can regulate the detection voltage V_D by using a Zener diode ZD3. However, the structure of the voltage dividing-voltage regulating circuit Ckt_Dsv is not limited to the implementation as that shown in FIG. 2.

For example, the voltage detection dimming unit VU may include a control logic (not shown), and the control logic can output a dimming signal S_V to the PWM signal generation unit PWMU to increase or decrease the duty cycle of the PWM driving signal S_PWM according to the turn-on/off state of the AC power supply 232. When the voltage detection dimming unit VU detects that the turn-on/off state of the AC power supply 232 is changed, the control logic can accumulate the adjustment based on the previously adjusted duty cycle, and output the corresponding dimming signal S_V to adjust the duty cycle of the PWM driving signal S_PWM. Therefore, the voltage detection dimming unit VU can sequentially increase or decrease the light-emitting intensity of the LED string 10 to implement the segmental dimming. For example, when the voltage detection dimming unit VU detects that the AC power supply 232 is turned on for the first time, the voltage detection dimming unit VU outputs the dimming signal S_V capable of adjusting the PWM driving signal S_PWM to, for example, 50% of the duty cycle. When the voltage detection dimming unit VU detects that the AC power supply 232 is turned off and is turned on again, the voltage detection dimming unit VU outputs the dimming signal S_V capable of adjusting the PWM driving signal S_PWM to, for example, 60% of the duty cycle, and the others are deduced by analogy.

Moreover, in the buck power conversion circuit 210, the electricity feedback circuit Ckt_Fb coupled between the power supply pin PIN_V and the output node Nout can provide a feedback current I_FB to the power supply pin PIN_V during the period of driving the LED string 10, so as to provide current to the power supply of the control chip 220. Here, the electricity feedback circuit Ckt_Fb can be implemented by a feedback path formed by connecting a Zener diode ZD2, a resistor R3 and a diode D2 in series, though the invention is not limited thereto.

The PWM signal generation unit PWMU operates under the power supply voltage VCC provided by the DC voltage generation circuit 230 to generate the PWM driving signal S_PWM, and outputs the PWM driving signal S_PWM through the output pin PIN_O to switch the power switch SW on the power switch path 212, and through feedback of the current flowing through a second resistor R2, the LED string 10 is operated under the constant current to emit light. For example, the PWM signal generation unit PWMU can be implemented by a circuit structure composed of a DC reference signal generator, a ramp signal generator, a comparator and an SR flip-flop.

In detail, the PWM signal generation unit PWMU may compare a DC reference signal generated by the DC reference signal generator with a ramp signal generated by the ramp signal generator to generate the PWM driving signal S_PWM having a PWM characteristic, and the duty cycle of the PWM driving signal S_PWM can be further adjusted through an operation of the SR flip-flop.

According to the above description, those skilled in the art should learn how to implement the function of the PWM generation unit PWMU through the aforementioned circuit, and a detailed circuit structure of the PWM signal generation unit PWMU is not illustrated.

Moreover, the PWM signal generation unit PWMU may also include a frequency jittering unit (not shown), and so as to decrease the influence of electromagnetic interference (EMI) through a frequency jittering technique.

The frequency setting unit FU is coupled to the PWM signal generation unit PWMU and the frequency setting circuit Ckt_Freq of the buck power conversion circuit 210, and is configured to set a frequency of the PWM driving signal S_PWM in response to an electrical characteristic of the frequency setting circuit Ckt_Freq during an initialization period of the LED driving apparatus 200. The frequency setting unit FU can adjust the frequency of the PWM driving signal S_PWM by changing a level of a DC reference signal in the PWM signal generation unit PWMU or changing a slope of the ramp signal, which is not limited by the invention.

In the present embodiment, the frequency setting circuit Ckt_Freq can be implemented by a resistor, for example, the frequency setting circuit Ckt_Freq includes the first resistor R1, and a designer can set the frequency of the PWM driving signal S_PWM by adjusting a resistance value of the first resistor R1, though the frequency setting circuit Ckt_Freq of the invention is not limited to be implemented by the resistor.

In detail, a first end of the first resistor R1 is coupled to the output pin PIN_O, and a second end of the first resistor R1 is coupled to the node N1 on the current switch path 212. During the initialization period, the PWM signal generation unit PWMU is disabled and does not output the PWM driving signal S_PWM, and the frequency setting unit FU provides a setting current flowing through the first resistor R1 through the output terminal (PIN_O).

Now, the frequency setting unit FU obtains a frequency setting signal S_F according to the setting current and a voltage level constructed on the output pin PIN_O by the first resistor R1. Since the setting current provided by the frequency setting unit FU is a constant current, the frequency setting signal S_F relates to the resistance value of the first resistor R1.

Further, the frequency setting unit FU can obtain the frequency setting signal S_F based on the voltage level on the output pin PIN_O by using a counting or a table look-up method, and accordingly set the frequency of the PWM driving signal S_PWM. For example, the frequency setting unit FU can perform counting in response to the voltage level on the output pin PIN_O, and performs digital-to-analog conversion on a counting value, and feeds back the same to a comparator (not shown) for comparing with the voltage level on the output pin PIN_O, so as to obtain the frequency setting signal S_F corresponding to different voltage level.

On the other hand, the frequency setting unit FU can also look up a frequency setting table (not shown) including corresponding relations of the voltage levels and the frequency setting values to obtain the frequency setting signal S_F, where the frequency setting table can be built in the frequency setting unit FU, or can be stored in a memory unit (not shown) of the control chip 220, or read by the frequency setting unit FU from an external electronic apparatus, which is not limited by the invention.

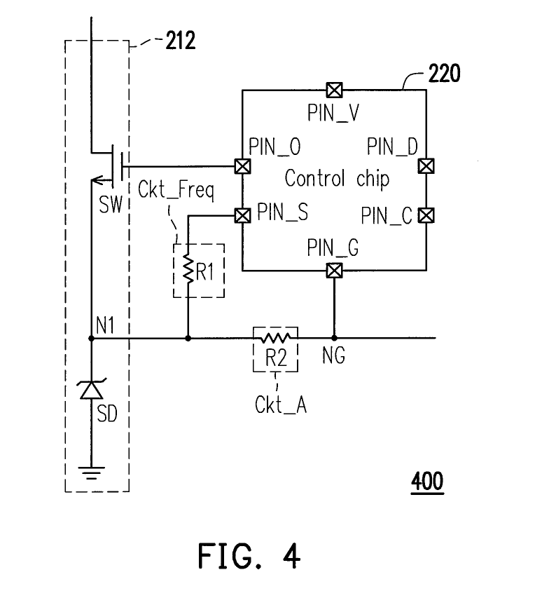

Moreover, the frequency setting circuit Ckt_Freq is not limited to have a configuration as that shown in FIG. 2, but may also have a configuration as that shown in FIG. 4. FIG. 4 is a partial schematic diagram of an LED driving apparatus according to still another embodiment of the invention. A structure of the LED driving apparatus 400 of FIG. 4 is similar the structure of the LED driving apparatus 200 of FIG. 2, so that only the partial schematic diagram of the LED driving apparatus 400 is illustrated.

Referring to FIG. 2 and FIG. 4, a difference between FIG. 4 and FIG. 2 is that the first resistor R1 used for implementing the frequency setting circuit Ckt_Freq is connected in series between the sensing pin PIN_S of the control chip 220 and the power switch path 212 of the buck power conversion circuit 210. Now, the frequency setting unit FU of the control chip 220 is correspondingly coupled to the sensing pin PIN_S, and based on the frequency setting method similar to that of the embodiment of FIG. 2, the frequency of the PWM driving signal S_PWM is set in response to the resistance value of the first resistor R1 during the initialization period.

In other words, the frequency setting circuit Ckt_Freq may also achieve the frequency setting effect similar to that of FIG. 2 by using the configuration of FIG. 4. Therefore, as long as the frequency setting unit FU can obtain the corresponding frequency setting signal S_F according to different electrical characteristic of the frequency setting circuit Ckt_Freq during the initialization period, and the frequency setting unit FU accordingly sets the frequency of the PWM driving signal S_PWM according to the frequency setting signal S_F, the frequency setting circuit Ckt_Frequ and the frequency setting unit FU of any structure and configuration are considered to be within the scope of the invention.

Referring to FIG. 2 and FIG. 3, the current sensing unit AU is coupled to the PWM signal generation unit PWMU, and is coupled to the current sensing circuit Ckt_A through the sensing pin PIN_S, and is configured to adjust the duty cycle of the PWM driving signal S_PWM in response to the current flowing through the current sensing circuit Ckt_A.

In the present embodiment, the current sensing circuit Ckt_A can be implemented by a resistor, for example, the current sensing circuit Ckt_A includes the second resistor R2, though the current sensing circuit Ckt_A of the invention is not limited to be implemented by the resistor.

In detail, a first end of the second resistor R2 is coupled to the sensing pin PIN_S and the power switch path 212, and a second end of the second resistor R2 is coupled to the ground pin PIN_G. The current sensing unit AU can implement overcurrent protection in response to the current flowing through the second resistor R2, and decreases the duty cycle of the PWM signal S_PWM to protect the LED driving apparatus 200 when the current flowing through the second resistor R2 is too high. The current sensing unit AU can generate the corresponding current sensing signal S_C in response to the current flowing through the second resistor R2.

For example, the current sensing unit AU retrieves a voltage of the node N1 to server as the current sensing signal S_C. Then, the current sensing unit AU uses a comparator circuit (not shown) to compare the current sensing signal S_C with a predetermined overcurrent reference signal to determine whether the current flowing through the second resistor R2 exceeds a predetermined current protection value, so as to determine whether to output an overcurrent protection signal S_OC to adjust the duty cycle of the PWM signal S_PWM.

Moreover, during the period that the LED driving apparatus 200 drives the LED string 10, a current direction of the current flowing through the second resistor R2 is from the node N1 to the node NG. Therefore, based on the resistance value of the second resistor R2 and the voltage drop caused by the current flowing through the second resistor R2, although the sensing pin PIN_S is directly connected to the power switch path 212, the voltage level thereof is still greater than the voltage level of the ground pin PIN_G.

On the other hand, besides the circuit protection mechanism of overcurrent protection, the control chip 220 may also have multiple circuit protection mechanisms, for example, over-voltage protection, over-temperature protection and low voltage locking, etc. In the present embodiment, the control chip 220, for example, includes a circuit protection structure including an over-voltage protection unit OVP, a low voltage locking unit UVLO and an over-temperature protection unit OTP, though the invention is not limited thereto.

In detail, the over-voltage protection unit OVP is coupled to the PWM signal generation unit PWMU, and is configured to detect whether the power supply voltage VCC exceeds a predetermined upper limit voltage. When the power supply voltage VCC exceeds the predetermined upper limit voltage, the PWM signal generation unit PWMU stops generating the PWM driving signal S_PWM.

The low voltage locking unit UVLO is coupled to the PWM signal generation unit PWMU, and is configured to detect whether the power supply voltage VCC exceeds a predetermined lower limit voltage. When the power supply voltage VCC does not exceed the predetermined lower limit voltage, the PWM signal generation unit PWMU stops generating the PWM driving signal S_PWM to prevent misoperation of each of the circuit units.

The over-temperature protection unit OTP is coupled to the PWM signal generation unit PWMU, and is configured to detect whether a temperature of the control chip 220 exceeds a temperature threshold, where when the temperature of the control chip 220 exceeds the temperature threshold, the PWM signal generation unit PWMU stops generating the PWM driving signal S_PWM to avoid overheat of the control chip 220 to cause operation performance degradation or even burn of the control chip 220.

The compensation unit CU is coupled to the compensation circuit Ckt_Com through the compensation pin PIN_C, where the compensation unit CU provides a compensation signal S_COM to adjust the duty cycle of the PWM driving signal S_PWM. In detail, the compensation unit CU can compensate a propagation delay of the circuit operation of the LED driving apparatus 200 by comparing the signals of the PWM signal generation unit PWMU and the current sensing unit AU. For example, the compensation unit CU receives the current sensing signal S_C generated by the current sensing unit AU, and compares the current sensing signal S_C with the ramp signal used for generating the PWM driving signal S_PWM in the PWM signal generation unit PWMU, so as to determine a propagation delay state of the LED driving apparatus 200. Therefore, the compensation unit CU can output the corresponding compensation signal S_COM according to the comparison result to adjust the duty cycle of the PWM driving signal S_PWM, so as to compensate the propagation delay of the LED driving apparatus 200.

Moreover, the compensation unit CU can also compensate a phase margin of the LED driving apparatus 200 through the compensation circuit Ckt_Com, so as to improve operation stability, and avoid oscillation generated during operation of the LED driving apparatus 200 that influences the light-emitting characteristic of the LED string 10. The compensation circuit Ckt_Com can be implemented by a structure composed of capacitors C3 and C4 and a resistor R4 as that shown in FIG. 2, though the invention is not limited thereto.

It should be noticed that the circuit configuration of the buck power conversion circuit 210, the control chip 220 and the DC voltage generation circuit 230 is only an exemplary implementation of the invention. Actually, as long as the ground pin PIN_G of the control chip 220 is indirectly connected to the power switch path 212, and the voltage level of the ground pin PIN_G is the lowest in the control chip 220 through the voltage drop of a circuit device (for example, the second resistor R2), it is considered to be cope with the spirit of the invention.

In summary, the embodiment of the invention provides an LED driving apparatus, in which by indirectly coupling the ground pin of the control chip to the power switch path through a circuit device, the ground pin of the control chip has the lowest voltage level in the control chip, so as to avoid the problem of reverse conduction between the pins of the control chip. Moreover, the LED driving apparatus can set the frequency of the PWM driving signal in response to the electrical characteristic of the frequency setting circuit, so as to improve selectivity on circuit design.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-emitting diode (LED) driving apparatus, at least adapted to drive an LED string, and the LED driving apparatus comprising:
a buck power conversion circuit, coupled to the LED string, and having a power switch path; and
a control chip, coupled to the buck power conversion circuit, and configured to control an operation of the buck power conversion circuit,
wherein the control chip has a ground pin, and the ground pin is indirectly connected to the power switch path and is in a floating state.

2. The LED driving apparatus as claimed in claim 1, wherein the buck power conversion circuit further comprises a frequency setting circuit, the control chip further has an output pin, and the control chip comprises:
a pulse width modulation (PWM) signal generation unit, operated under a power supply voltage to generate a PWM driving signal, and outputting the PWM driving signal through the output pin to switch a power switch on the power switch path, such that the LED string is operated under a constant current to emit light; and
a frequency setting unit, coupled to the PWM signal generation unit and the frequency setting circuit, and configured to set a frequency of the PWM driving signal in response to an electrical characteristic of the frequency setting circuit during an initialization period of the LED driving apparatus.

3. The LED driving apparatus as claimed in claim 2, wherein the power switch has a first terminal, a second terminal and a control terminal, the first terminal of the power switch receives the power supply voltage, the second terminal of the power switch is coupled to a ground potential, and the control terminal of the power switch is coupled to the output pin to receive the PWM driving signal.

4. The LED driving apparatus as claimed in claim 2, wherein the frequency setting circuit comprises a first resistor, a first end of the first resistor is coupled to the output pin, and a second end of the first resistor is coupled to the power switch path, wherein the frequency setting unit sets the frequency of the PWM driving signal in response to a resistance value of the first resistor during the initialization period.

5. The LED driving apparatus as claimed in claim 2, wherein the buck power conversion circuit further comprises a current sensing circuit, the control chip further has a sensing pin, and the control chip further comprises:
a current sensing unit, coupled to the PWM signal generation unit, and coupled to the current sensing circuit through the sensing pin, and configured to adjust a duty cycle of the PWM driving signal in response to a current flowing through the current sensing circuit.

6. The LED driving apparatus as claimed in claim 5, wherein the frequency setting circuit comprises a first resistor, the first resistor is connected in series between the sensing pin and the power switch path, wherein the frequency setting unit sets the frequency of the PWM driving signal in response to a resistance value of the first resistor during the initialization period.

7. The LED driving apparatus as claimed in claim 5, wherein the current sensing circuit comprises a second resistor, a first end of the second resistor is coupled to the sensing pin and the power switch path, and a second end of the second resistor is coupled to the ground pin, wherein a voltage level of the sensing pin is greater than a voltage level of the ground pin during a period when the LED driving apparatus drives the LED string.

8. The LED driving apparatus as claimed in claim 2, wherein the control chip further has a power supply pin, and the LED driving apparatus further comprises:
a direct current (DC) voltage generation circuit, configured to generate the power supply voltage,
wherein the control chip receives the power supply voltage through the power supply pin, and is operated under the power supply voltage to control the operation of the buck power conversion circuit.

9. The LED driving apparatus as claimed in claim 8, wherein the DC voltage generation circuit comprises:
an alternating current (AC) power supply, configured to provide an AC voltage; and
a bridge rectifier, coupled to the AC power supply, and configured to rectify the AC voltage to generate the power supply voltage.

10. The LED driving apparatus as claimed in claim 9, wherein the buck power conversion circuit further comprises a voltage dividing-voltage regulating circuit, the control chip further has a detection pin, and the control chip further comprises:
a voltage detection dimming unit, coupled to the DC voltage generation circuit through the detection pin and the voltage dividing-voltage regulating circuit, and configured to adjust a duty cycle of the PWM driving signal in response to a turn-on/off state of the AC power supply.

11. The LED driving apparatus as claimed in claim 10, wherein the DC voltage generation circuit further comprises:
a diode, having an anode coupled to the bridge rectifier, and a cathode coupled to the power supply pin; and
a voltage regulation capacitor, coupled between the cathode of the diode and a ground voltage.

12. The LED driving apparatus as claimed in claim 11, wherein the voltage detection dimming unit obtains a detection voltage in response to a voltage on the anode of the diode, and compares the detection voltage with a reference detection voltage to obtain the turn-on/off state of the AC power supply.

13. The LED driving apparatus as claimed in claim 8, wherein the buck power conversion circuit further comprises:
an electricity feedback circuit, coupled to the power supply pin and an anode of the LED string, and configured to provide a feedback current to the power supply pin.

14. The LED driving apparatus as claimed in claim 2, wherein the control chip further comprises:
an over-voltage protection unit, coupled to the PWM signal generation unit, and configured to detect whether the power supply voltage exceeds a predetermined upper limit voltage,
wherein when the power supply voltage exceeds the predetermined upper limit voltage, the PWM signal generation unit stops generating the PWM driving signal.

15. The LED driving apparatus as claimed in claim 2, wherein the control chip further comprises:
a low-voltage locking unit, coupled to the PWM signal generation unit, and configured to detect whether the power supply voltage exceeds a predetermined lower limit voltage,
wherein when the power supply voltage does not exceed the predetermined lower limit voltage, the PWM signal generation unit stops generating the PWM driving signal.

16. The LED driving apparatus as claimed in claim 2, wherein the control chip further comprises:
an over-temperature protection unit, coupled to the PWM signal generation unit, and configured to detect whether a temperature of the control chip exceeds a temperature threshold,
wherein when the temperature of the control chip exceeds the temperature threshold, the PWM signal generation unit stops generating the PWM driving signal.

17. The LED driving apparatus as claimed in claim 2, wherein the buck power conversion circuit further comprises a compensation circuit, the control chip further has a compensation pin, and the control chip further comprises:
a compensation unit, coupled to the compensation circuit through the compensation pin, wherein the compensation unit provides a compensation signal to adjust a duty cycle of the PWM driving signal.

18. The LED driving apparatus as claimed in claim 2, wherein the buck power conversion circuit further comprises:
a filter circuit, coupled between the ground pin and the LED string, and configured to generate the constant current to drive the LED string in response to a switch operation of the power switch.

19. The LED driving apparatus as claimed in claim 18, wherein the filter circuit comprises:
an inductor, having a first end coupled to the output pin, and a second end coupled to the anode of the LED string; and
a capacitor, having a first end coupled to the second end of the inductor and the anode of the LED string, and a second end coupled to the ground potential.
